(19) United States
(12) Patent Application Publication
(10) Pub. No.: US 2019/0337797 A1
(43) Pub. Date: Nov. 7, 2019

(54) SADDLE PAD

(71) Applicant: EquiFit, Inc., Dedham, MA (US)

(72) Inventors: Alexandra Cherubini, Boston, MA (US); Richard Clement, Sudbury, MA (US); David Attal, Dedham, MA (US)

(73) Assignee: EquiFit, Inc., Dedham, MA (US)

(21) Appl. No.: 16/400,342

(22) Filed: May 1, 2019

Related U.S. Application Data
(60) Provisional application No. 62/665,150, filed on May 1, 2018.

(51) Int. Cl. B68C 1/12

(52) U.S. Cl. CPC B68C 1/12

(57) ABSTRACT

A saddle pad configured to provide a horse with pressure relief along its spine from a saddle and the saddle pad. The saddle pad may include a first side panel, a second side panel, and a central panel. The central panel may include a first end and a second end. The central panel may be wider at the first end than at the second end, and the central panel may be configured to extend into a gullet of the saddle and away from the horse's spine. In some embodiments, the central panel may be configured to stay off of the horse's withers. In some embodiments, the central panel may be configured to stay in the gullet of the saddle and away from the horse's spine for the entire length of the saddle.

### CROSS-REFERENCE TO RELATED APPLICATION

The present application claims the benefit of priority to U.S. Provisional Application Ser. No. 62/665,150, filed on May 1, 2018, which is incorporated herein by reference in its entirety.

### BACKGROUND

### Field of Invention

The present invention relates to a saddle pad configured to provide pressure relief for a horse's withers and spine.

### Discussion of the Background

Conventional saddle pads are made of two panels that are joined down the center. When a saddle is fitted over a conventional saddle pad, the conventional saddle pad may have the ability to stay up off the horse's withers but does not have the ability to stay up off of the horse's spine, especially not for the entire length of the saddle and saddle pad. As a result, the saddle pad, and in particular the central seam in a conventional saddle pad, puts pressure on the horse's spine, which can cause great discomfort to the horse. Improved saddle pads are needed to provide better pressure relief.

### SUMMARY

Aspects of the present invention relate to providing a horse with improved pressure relief from its saddle and saddle pad. One aspect of the invention may provide a saddle pad configured to stay up off a horse's withers and spine, providing the horse pressure relief from its saddle and saddle pad. The saddle pad may include a first side panel, a second side panel, and a central panel. The central panel may have first and second ends and may be wider at the first end than at the second end. The central panel may be configured to extend into a gullet of the saddle and away from the horse's withers and spine.

In some embodiments, the saddle pad may further include a first seam and a second seam, the first seam may connect the first side panel and the central panel, the first seam may extend from the first end of the central panel to the second end of the central panel, the first seam may be configured to pass through the gullet of the saddle along a gullet end of a first panel of the saddle, the second seam may connect the second side panel and the central panel, the second seam may extend from the first end of the central panel to the second end of the central panel, and the second seam may pass through the gullet of the saddle along a gullet end of a second panel of the saddle.

In some embodiments, the saddle pad may include a cotton twill exterior. In some embodiments, the saddle pad may include a moisture wicking interior. In some embodiments, the saddle pad may include a flannel interior. In some embodiments, the saddle pad may include a slip-resistant interior. In some embodiments, the saddle pad may have an approximately rectangular shape. In some embodiments, the saddle pad may have a shape that approximately matches the shape of all or a portion of the saddle.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 is a perspective view of the front, top, and right side of a saddle pad embodying aspects of the present invention.

FIG. 2 is a front view of a saddle pad embodying aspects of the present invention.

FIG. 3 is a perspective view of the rear, top, and right side of a saddle pad embodying aspects of the present invention.

FIG. 4 is a left side view of a saddle pad embodying aspects of the present invention.

FIG. 5 is a top view of a saddle pad embodying aspects of the present invention.

FIG. 6 is a bottom view of a saddle pad embodying aspects of the present invention.

FIG. 7 is an exploded view of the panels of a saddle pad embodying aspects of the present invention.

FIG. 8 is a perspective view of the front and left side of a saddle pad embodying aspects of the present invention in use.

FIG. 9 is a perspective view of the rear and left side of a saddle pad embodying aspects of the present invention in use.

FIG. 10 is a perspective view of the rear and top of a saddle pad embodying aspects of the present invention in use.

### DETAILED DESCRIPTION OF PREFERRED EMBODIMENTS

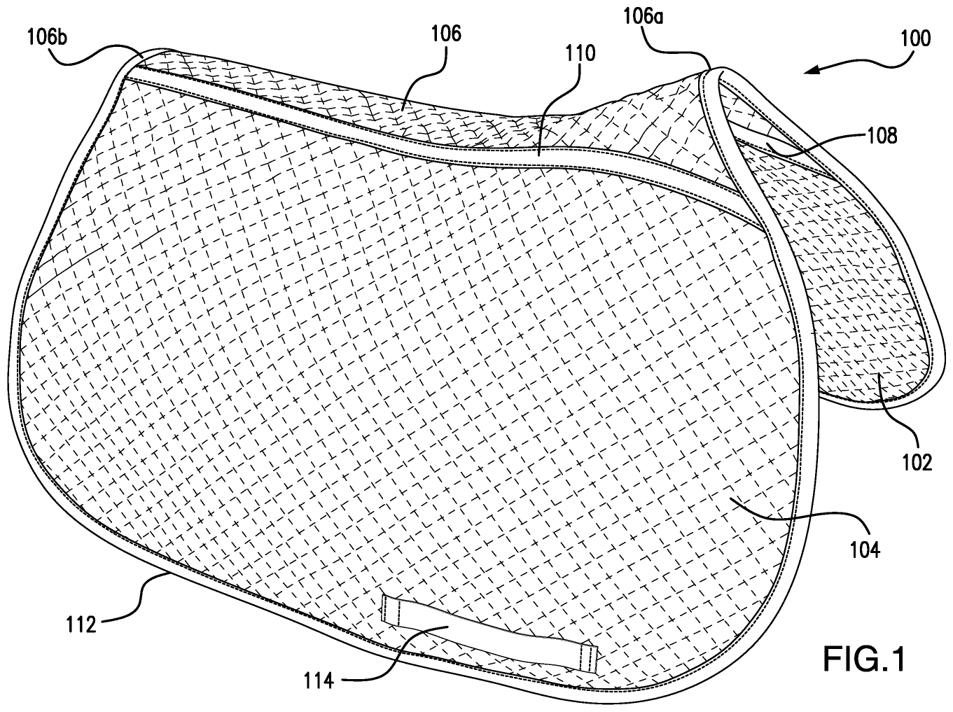

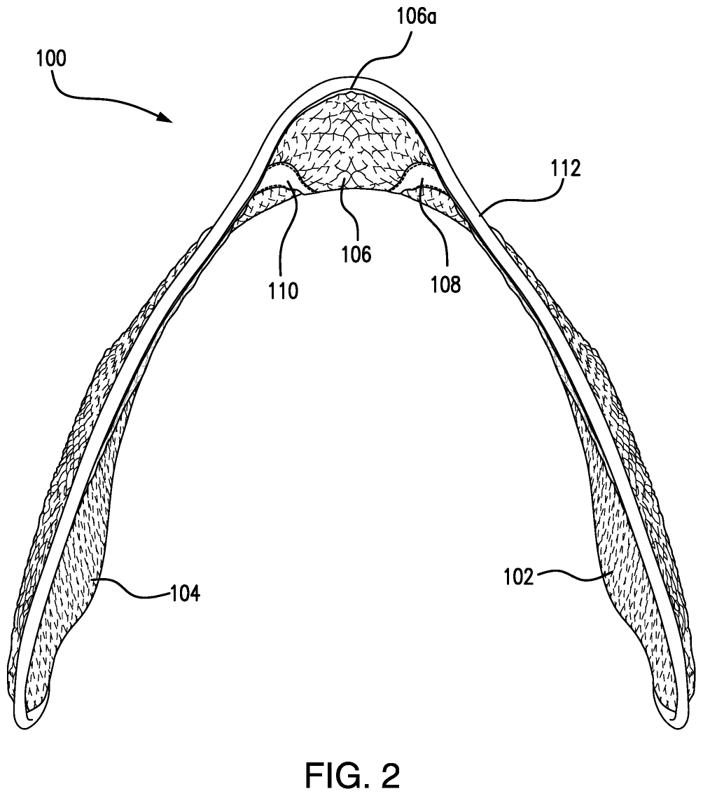

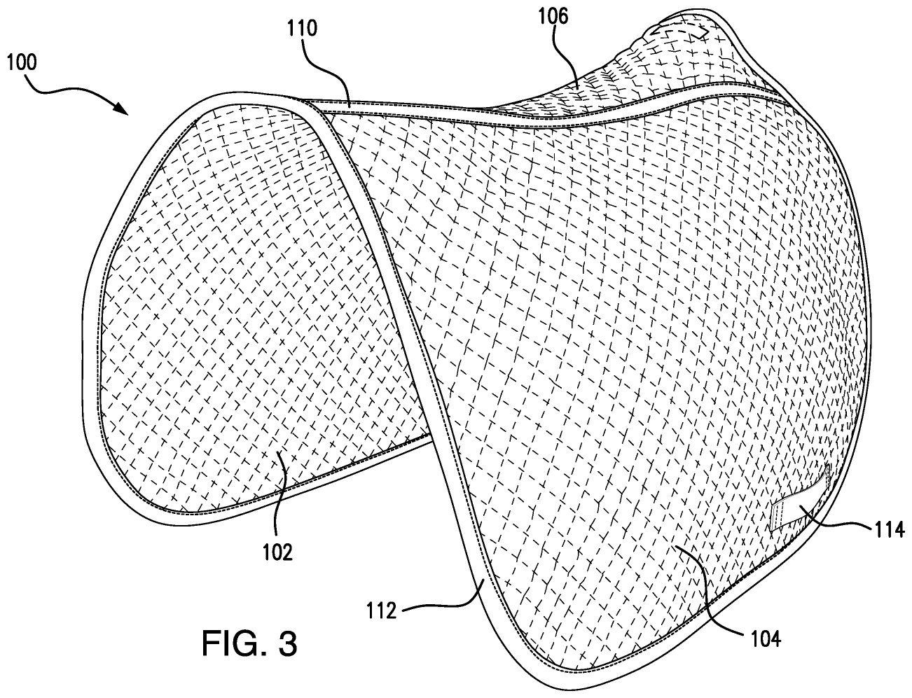

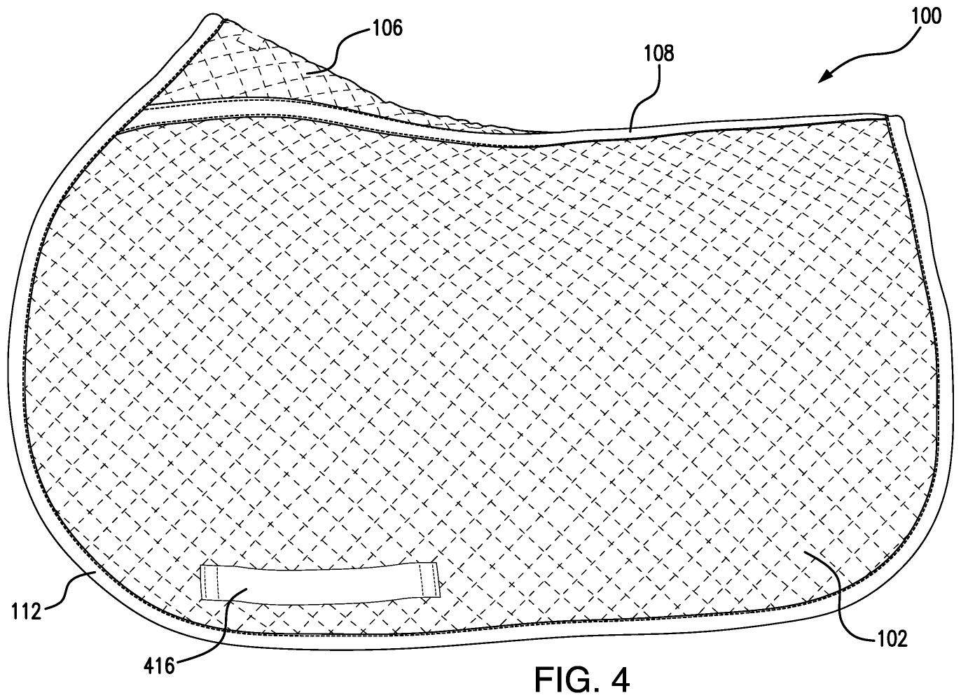

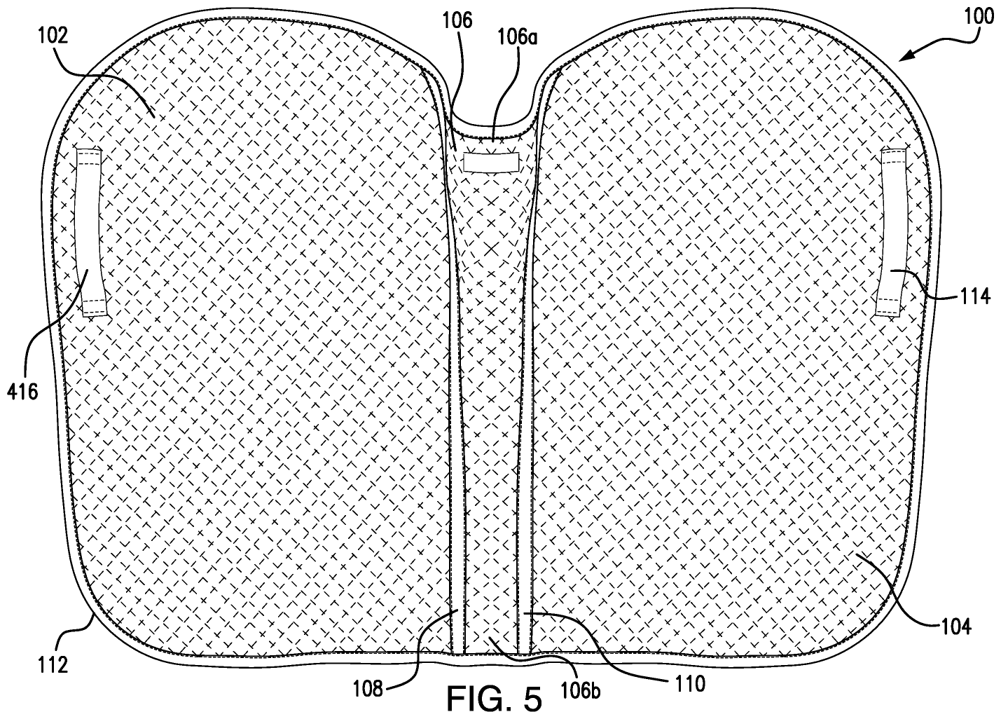

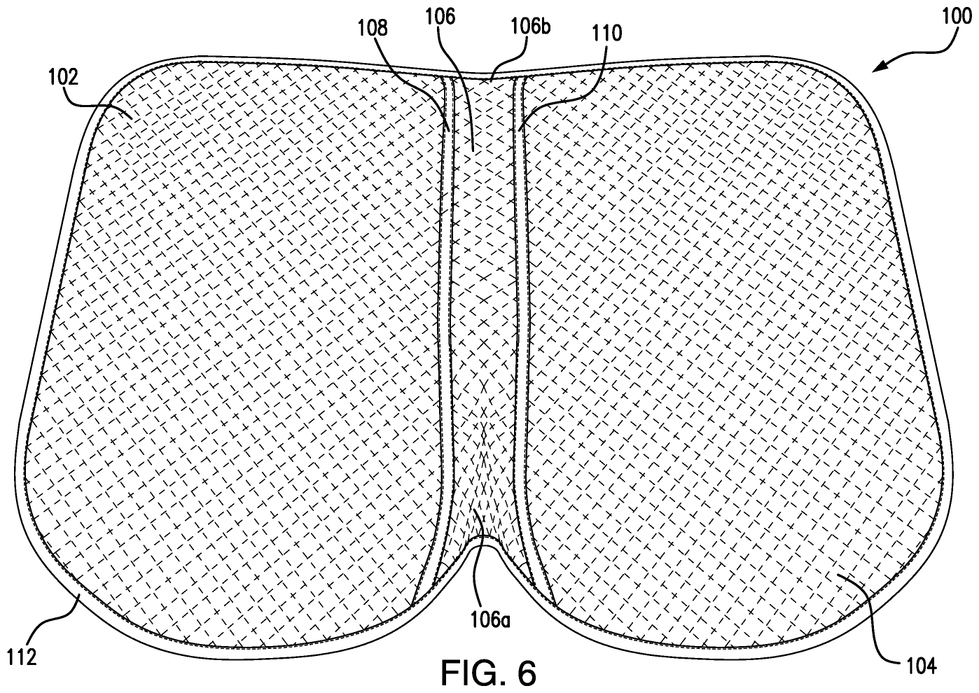

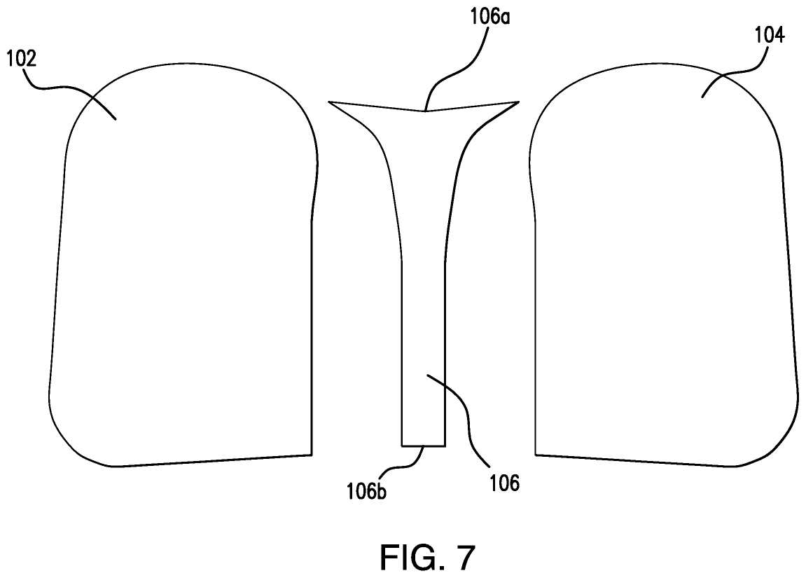

FIGS. 1-6 illustrate a saddle pad 100 embodying aspects of the present invention. In some embodiments, as illustrated in FIGS. 1-6, the saddle pad 100 may include a first side panel 102, a second side panel 104, and a central panel 106. FIG. 7 illustrates a non-limiting embodiment of the panels 102, 104, and 106 of the saddle pad 100 when flat. In some embodiments, as shown in FIG. 7, the central panel 106 may have a first end 106a and a second end 106b, and the central panel 106 may be wider at the first end 106a than at the second end 106b.

In some embodiments, as illustrated in FIGS. 1-6, the saddle pad 100 may include a first seam 108 and a second seam 110. In some embodiments, the first seam 108 may connect the first side panel 102 and the central panel 106. In some embodiments, the first seam 108 may extend from the first end 106a of the central panel 106 to the second end 106b of the central panel 106. In some embodiments, the second seam 110 may connect the second side panel 104 and the central panel 106. In some embodiments, the second seam 110 may be configured to extend from the first end 106a of the central panel 106 to the second end 106b of the central panel 106. In some non-limiting embodiments, the saddle pad 100 may include a third seam 112 on all or a portion of the circumference of the saddle pad 100. In some non-limiting embodiments, one or more of the first seam 108, second seam 110, and third seam 112 may be flat seams.

In some non-limiting embodiments, as shown in FIGS. 1 and 3-5, the saddle pad 100 may include one or more of straps 114 and 416. In some non-limiting embodiments, one or more of the straps 114 and 416 may be configured to hold the saddle pad in place with respect to the girth of a saddle. In some non-limiting embodiments, the strap 114 may be on the first side panel 102, and the strap 416 may be on the second side panel 104.

In some embodiments, the exterior of the saddle pad 100 may be made from a durable material. In some non-limiting embodiments, the saddle pad 100 may include a cotton twill exterior. However, this is not required and, in some alternative embodiments, the saddle pad 100 may have an exterior made of a different material. In some non-limiting embodiments, the interior of the saddle pad 100 may be moisture wicking and/or slip resistant. In some non-limiting embodiments, the saddle pad 100 may include a flannel interior. However, this is not required and, in some alternative embodiments, the saddle pad 100 may have an interior made of a different material. In some non-limiting embodiments, the saddle pad 100 may have a dual-density poly-fill construction.

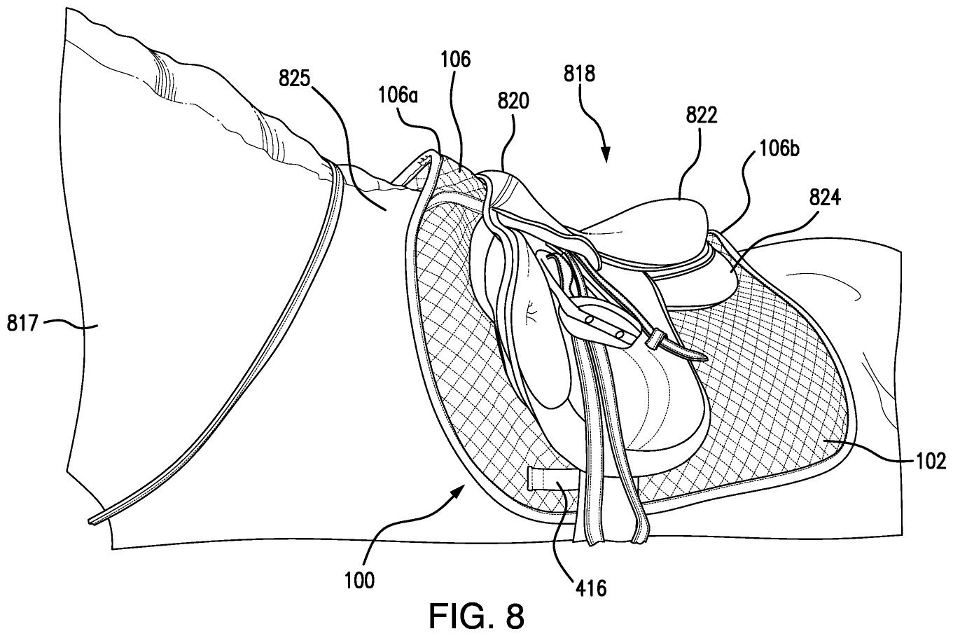

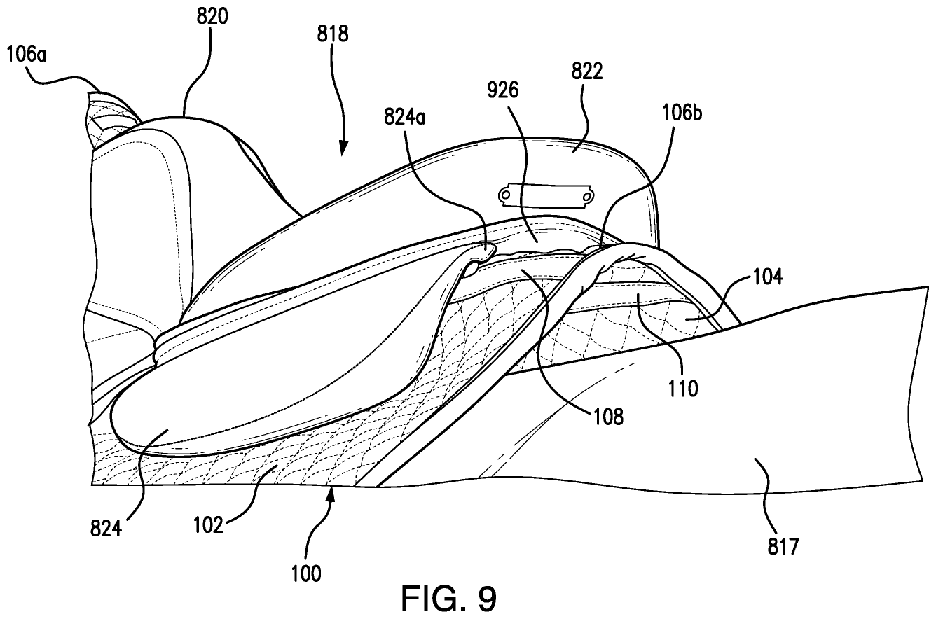

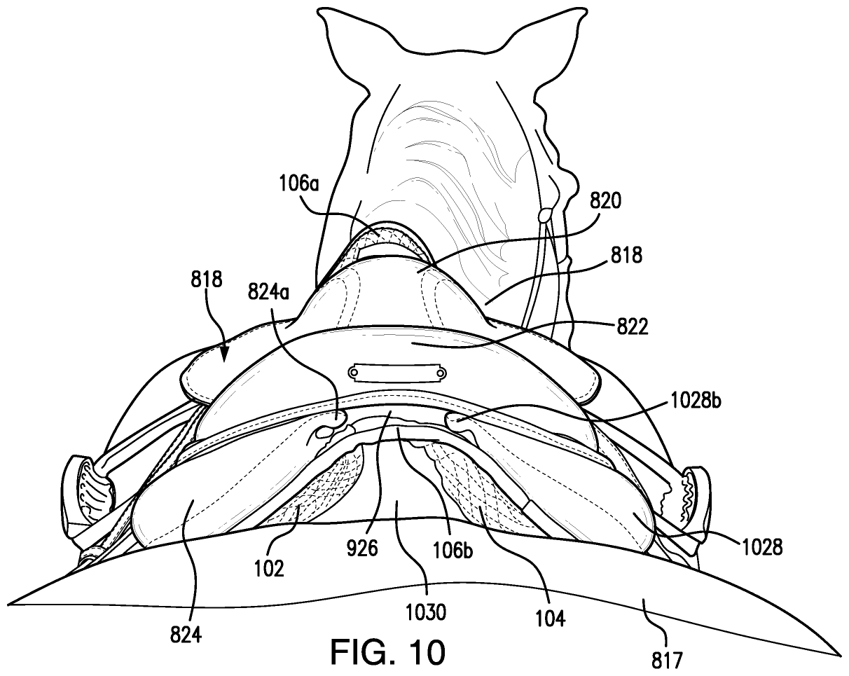

FIGS. 8-10 illustrate the saddle pad 100 embodying aspects of the present invention in use. In some embodiments, the saddle pad 100 may be placed on the back of a horse 817 underneath a saddle 818. The saddle 818 may include a pommel 820, a cantle 822, a first panel 824, a second panel 1028, and a gullet (or channel) 926. In some embodiments, the saddle pad 100 may be configured such that the first end 106a of the central panel 106 is the end of the central panel 106 closest to the pommel 820 of the saddle 818. In some embodiments, the saddle pad 100 may be configured such that the second end 106b of the central panel 106 is the end of the central panel 106 closest to the cantle 822 of the saddle 818. In some embodiments, as shown in at least FIGS. 9 and 10, the central panel 106 of the saddle pad 100 may be configured to bridge the spine 1030 of the horse 817. In some embodiments, as shown in at least FIGS. 9 and 10, the saddle pad 100 may be configured such that the central panel 106 is raised off of the horse's back inside the gullet 926 of the saddle 818 such that the saddle pad 100 contacts neither the spine 1030 nor the withers 825 of the horse 817. Accordingly, with the saddle pad raised into the gullet 926 of the saddle 818, the horse's shoulders and back may be allowed free movement.

In some embodiments, the shape and/or width of the central panel 106 of the saddle pad 100 may be configured to reduce the occurrence of pressure points from the saddle (e.g., from the panels 814 and 1028 of the saddle 818) and/or the saddle pad 100. In some embodiments, the shape and/or width of the central panel 106 of the saddle pad 100 may be configured based on the shape and/or size of the saddle 818. In some embodiments, the shape and/or width of the central panel 106 of the saddle pad 100 may be configured based on the shape and/or size of the horse 817. In some embodiments, the shape and/or width of the central panel 106 may keep the pad raised into the gullet 916 of the saddle 818 after being set there by the horse's groom. In some non-limiting embodiments, one or more of the first seam 108, second seam 110, and third seam 112 may be configured to alleviate pressure spots (e.g., by being flat seams).

In some embodiments, the first seam 108 may be configured to pass through the gullet 926 of the saddle 818 and along a gullet end 824a of a first panel 824 of the saddle 818. In some embodiments, the second seam 110 may be configured to pass through the gullet 926 of the saddle 818 and along a gullet end 1028a of a second panel 1028 of the saddle 818. In some embodiments, the central panel 106 may be configured to extend into the gullet 926 of the saddle 818 and away from the spine 1030 of the horse 817. In some non-limiting embodiments, the central panel 106 may be configured to extend into the gullet 926 of the saddle 818 and away from the withers 825 of the horse 817. In some non-limiting embodiments, the central panel 106 may be configured to stay in the gullet 926 of the saddle 818 and away from the entirety of the spine 1030 of the horse 817 when the horse is moving. In some non-limiting embodiments, the central panel 106 may be configured to stay in the gullet 926 of the saddle 818 and away from the withers 825 of the horse 817 when the horse is moving.

In some embodiments, as shown in FIGS. 1-10, the saddle pad 100 may be a “square pad” having an approximately rectangular shape. However, this is not required, and, in some alternative embodiments, the saddle pad 100 may have a different shape. For example, in some non-limiting alternative embodiments, the saddle pad 100 may be a “hunter pad,” “half pad,” or “jumper pad” having a shape that approximately matches the shape of all or a portion of the saddle 818.

Embodiments of the present invention have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

What is claimed is:

1. A saddle pad configured to provide a horse with pressure relief along its spine from a saddle and the saddle pad, the saddle pad comprising:
a first side panel;
a second side panel; and
a central panel having a first end and a second end, wherein the central panel is wider at the first end than at the second end, and the central panel is configured to extend into a gullet of the saddle and away from the horse's spine.

2. The saddle pad of claim 1, further comprising:
a first seam connecting the first side panel and the central panel, wherein the first seam extends from the first end of the central panel to the second end of the central panel, and the first seam is configured to pass through the gullet of the saddle along a gullet end of a first panel of the saddle; and
a second seam connecting the second side panel and the central panel, wherein the second seam extends from the first end of the central panel to the second end of the central panel, and the second seam is configured to pass through in the gullet of the saddle and along a gullet end of a second panel of the saddle.

3. The saddle pad of claim 2, wherein one or more of the first and second seams are flat seams.

4. The saddle pad of claim 1, wherein the central panel is configured to stay off of the horse's withers.

5. The saddle pad of claim 1, further comprising a cotton twill exterior.

6. The saddle pad of claim 1, further comprising a moisture-wicking interior.

7. The saddle pad of claim 1, further comprising a flannel interior.

8. The saddle pad of claim 1, further comprising a slip-resistant interior.

9. The saddle pad of claim 1, wherein the central panel is configured to stay in the gullet of the saddle and away from the horse's spine for the entire length of the saddle.

10. The saddle pad of claim 1, wherein the saddle pad has an approximately rectangular shape.

11. The saddle pad of claim 1, wherein the saddle pad has a shape that approximately matches the shape of all or a portion of the saddle.
